(19) United States
(12) Patent Application Publication
(10) Pub. No.: US 2024/0034894 A1
(43) Pub. Date: Feb. 1, 2024

(54) PHOTO-CROSSLINKED HYALURONIC ACID BIO-INK FOR BIO-PRINTING, METHOD FOR PREPARING SAME, AND BIOLOGICAL STRUCTURE CAPABLE OF CONTROLLING PHYSICAL PROPERTIES USING SAME

(71) Applicant: AJOU UNIVERSITY INDUSTRY-ACADEMIC COOPERATION FOUNDATION, Gyeonggi-do (KR)

(72) Inventors: Moon Suk KIM, Gyeonggi-do (KR); Joon Yeong PARK, Jeollanam-do (KR)

(73) Assignee: AJOU UNIVERSITY INDUSTRY-ACADEMIC COOPERATION FOUNDATION, Gyeonggi-do (KR)

(21) Appl. No.: 18/265,218

(22) PCT Filed: Nov. 2, 2021
(86) PCT No.: PCT/KR2021/015656

§ 371 Date: Jun. 2, 2023

(30) Foreign Application Priority Data
Dec. 3, 2020 (KR) 10-2020-0167537

(51) Int. Cl. C09D 11/14; C08F 2/50; C08F 251/00; C09D 11/04; B33Y 70/00; B33Y 10/00

(52) U.S. Cl. CPC C09D 11/14; C08F 2/50; C08F 251/00; C09D 11/04; B33Y 70/00; B33Y 10/00

(57) ABSTRACT

The present invention relates to a bio-ink composition for bio-printing comprising a polymer into which methacrylate is introduced, a crosslinking agent having 1-10 acrylate functional groups, and a photoinitiator; a method for preparing same; and a printing biological structure for controlling physical properties using same. The bio-ink composition for bio-printing prepared according to the present invention can be implanted in vivo and has a very high degree of biocompatibility or cell viability. In addition, the bio-ink composition of the present invention can be effectively utilized for bio-printing because a biological structure can be produced that is capable of controlling physical properties or in vivo application even when irradiated with light for a short period of time.

### TECHNICAL FIELD

This application claims the benefit of Korean Patent Application No. 10-2020-0167537 filed on Dec. 3, 2020, the disclosure of which is incorporated herein by reference in its entirety.

The present invention relates to a bio-ink composition for bioprinting including a polymer into which methacrylate is introduced, a crosslinking agent having 1 to 10 acrylate functional groups, and a photoinitiator, a method of preparing the same and a printed biological structure for controlling physical properties using the same.

### BACKGROUND ART

Three-dimensional (3D) printing technology is a technology that uses data obtained through 3D modeling to create desired products through additive manufacturing. A stereolithography (SLA) method of building layers formed of a photocurable resin of which the surface is cured by irradiation with ultraviolet light, and a fused deposition modeling (FDM) method of depositing melted filament material layer by layer for 3D printing were devised. Recently, as basic technologies and application technologies using 3D printing technology have been actively developed in the United States, Europe, Japan and the like, the field of medical engineering has begun to pay attention to 3D printing technology.

3D bioprinting, one of the 3D printing technologies, is a technology for fabricating biological constructs or supports that can be implanted in vivo by printing living cells with bio-ink. The bioprinting technology is expected to be an effective solution to the shortage of organs for transplantation due to its advantages of creating desired shapes and structures. In order for such bio-ink to be used in practice, it must have sufficient physical properties to maintain a structure and be able to continuously function without the death of cells. That is, bio-ink plays a role of connecting tissue to tissue in order to regenerate lost tissue through a self-repair function as a support, and for this purpose, the bio-ink must have excellent cell compatibility for smooth tissue regeneration. Furthermore, it must have a pore structure that is three-dimensionally well connected in a certain size area so that cells can grow well in three dimensions while exchanging nutrients and excrements, and also must have biodegradability allowing the bio-ink to decompose and disappear according to the rate of tissue regeneration, and mechanical strength to maintain its shape during regeneration, as well as excellent biosafety. In particular, in the regeneration of hard tissues such as bones and teeth, it is important to secure mechanical properties according to the regeneration site.

Technologies using synthetic polymers, which are existing methods of fabricating supports, not only lack cell-recognition but also have a hydrophobic surface, making it difficult to be used as bio-ink. In addition, it is easy for synthetic polymers to maintain their shape based on sufficient physical properties, but the synthetic polymers have poor biocompatibility and biodegradability after transplantation in vivo. Further, when natural polymers are used, despite their excellent biocompatibility and biodegradability, the natural polymers have very low physical properties, requiring a synthetic polymer-based support during the manufacturing process, and cannot maintain their shape when made into a 3D structure, resulting in a delay in development of bio-ink.

Recently, with the development of a digital light processing (DLP) method of fabricating a 3D structure by harnessing visible light for modeling in units of surfaces, research on bio-ink for DLP is being actively conducted.

Korea Patent Publication No. 10-2018-0089474 relates to the light-activated production of a hydrogel, and discloses a hydrogel prepared by allowing a mixture of a polymer and a photoinitiator to be irradiated with visible light. However, research or description of a bio-ink composition using an acrylate-introduced polymer has not been disclosed.

### Technical Problem

The present applicant has made great efforts to provide bio-ink that can be implanted in vivo, has high biocompatibility and cell viability, and can control physical properties according to the purpose. As a result, the present applicant has recognized that, when methacrylate is introduced into a polymer and the polymer is photo-crosslinked with a crosslinking agent containing an acrylate functional group, a bio-ink that can be effectively applied in vivo and has controllable physical properties can be produced, thereby completing the present invention.

Accordingly, an object of the present invention is to provide a bio-ink composition for bioprinting including a polymer into which methacrylate is introduced, a crosslinking agent having 1 to 10 acrylate functional groups, and a photoinitiator, a method of preparing the same, and a biological structure having controllable physical properties using the same.

### Technical Solution

The present invention provides a method of preparing a bio-ink composition for bioprinting, which includes mixing a polymer into which methacrylate is introduced, a crosslinking agent having 1 to 10 acrylate functional groups, and a photoinitiator.

According to a preferred embodiment of the present invention, the polymer may be at least one selected from the group consisting of hyaluronic acid, chitosan, collagen, alginate, gelatin, albumin, carrageenan, Matrigel, hemoglobin, heparin, fibrin-gel and agarose.

According to a preferred embodiment of the present invention, the crosslinking agent may be at least one selected from the group consisting of polyethylene glycol diacrylate (PEGDA), glycerol trimethacrylate (GlyMA) and multi-arm polyethylene glycol (PEG).

According to a preferred embodiment of the present invention, the equivalent weight of the crosslinking agent may be in the range of 10 to 1000.

According to a preferred embodiment of the present invention, the photoinitiator may be at least one selected from the group consisting of lithium phenyl-2,4,6-trimethylbenzoylphosphinate (LAP), 2,2-dimethoxy-2-phenylacetonephenone (DMPA), 2-hydroxy-2-methylpropipphenone (HOMPP), [diethyl-(4-methoxybenzoyl)germyl]-(4-methoxyphenyl)methanone (Ivocerin), 1-[4-(2-hydroxyethoxy)-phenyl]-2-hydroxy-2-methyl-1-propane-1-one (IRGACURE 2959), bis-(2,4,6-trimethylbenzoyl) phenylphosphine oxide (Irgacure 819) and camphorquinone (CQ).

According to a preferred embodiment of the present invention, the bioprinting may be performed by at least one 3D bioprinting method selected from the group consisting of fused deposition modeling (FDM) with a light source, digital light processing (DLP), mask stereolithography (MSLA) and liquid crystal display (LCD).

In addition, the present invention provides a method of preparing a biological structure, which includes allowing a bio-ink composition prepared by the method of preparing the bio-ink composition to be irradiated with light to adjust physical properties of the bio-ink composition, or a biological structure prepared by the method of preparing a biological structure.

According to a preferred embodiment of the present invention, the polymer and the crosslinking agent in the composition may be photo-crosslinked.

According to a preferred embodiment of the present invention, the wavelength of the light may be in a range of 100 to 1500 nm.

According to a preferred embodiment of the present invention, the irradiation may be performed for 1 second to 60 seconds.

In addition, the present invention may provide a cartridge for a bioprinter including the bio-ink composition.

In the present invention, (1) HA-MA is prepared as an ink main composition by introducing (meth)acrylate (MA) into a side chain of hyaluronic acid (HA), and (2) a bio-ink containing polyethylene glycol diacrylate (PEGDA) containing 2 to 4 acrylate functional groups, glycerol trimethacrylate (GlyMA) or 4-arm polyethylene glycol acrylate (4-arm PEG-AC) as an ink auxiliary composition is prepared, and the bio-ink is irradiated with light, thereby providing a photo-crosslinked bioimplantable structure having controllable physical properties. The “bio-ink” may include living cells or biomolecules, and refers to a material applicable to bioprinting technology to fabricate a desired structure.

Specifically, a bio-ink including the same equivalent amount of PEGDA, 4-arm PEG-AC or GlyMA in the prepared HA-MA is prepared, and a bio-ink capable of controlling physical properties may be provided even when exposed to a UV light source for a short time.

The bio-ink may be applied to digital light processing (DLP), mask stereolithography (MSLA) or liquid crystal display (LCD) 3D printing that prints the object in units of surfaces using a light source, and fused deposition modeling (FDM) 3D printing with a light source, unlike the existing 3D printing (direct ink writing (DIW)) or fused deposition modeling (FDM)) method without a light source that prints in the form of a line.

In vivo implantation of bio-ink prepared using existing resin materials is difficult, but the hyaluronic acid (HA) material developed through the present invention can be implanted in vivo and is a material with very high biocompatibility, and also has various decomposition periods in the body according to structure and composition changes of hyaluronic acid (HA) and has high cell viability.

Further, unlike previously developed printing materials, the bio-ink of the present invention may fabricate a bioapplicable scaffold even by short-term light irradiation, and may also be used as a bio-ink into which cells are introduced because cells are introduced into the ink.

Hereinafter, the present invention will be described in more detail.

The present invention may provide a method of preparing a bio-ink composition for bioprinting, which includes mixing a polymer into which methacrylate is introduced, a crosslinking agent having 1 to 10 acrylate functional groups, and a photoinitiator, and a bio-ink composition prepared using the preparation method.

According to a preferred embodiment of the present invention, the polymer may be at least one selected from the group consisting of hyaluronic acid, chitosan, collagen, alginate, gelatin, albumin, carrageenan, Matrigel, hemoglobin, heparin, fibrin-gel and agarose, and may preferably be hyaluronic acid.

According to a preferred embodiment of the present invention, the crosslinking agent may preferably have 2 to 6 acrylate groups, more preferably, 2 to 4 acrylate groups. In addition, the crosslinking agent may also be referred to as “ink auxiliary composition” in the present specification, and may be at least one selected from the group consisting of polyethylene glycol diacrylate (PEGDA), glycerol trimethacrylate (GlyMA) and multi-arm polyethylene glycol (PEG).

According to a preferred embodiment of the present invention, the equivalent weight of the crosslinking agent may be in the range of 10 to 1000. The equivalent weight of the crosslinking agent may be preferably in the range of 50 to 700, more preferably in the range of 100 to 500.

The multi-arm polyethylene glycol (PEG) may be preferably 4-arm PEG-AC or 8-arm PEG-AC, and more preferably 4-arm PEG-AC. The polyethylene glycol (PEG) is a polymer form of ethylene oxide and is also called polyethylene oxide (PEO) or polyoxyethylene (POE) depending on its molecular weight.

According to a preferred embodiment of the present invention, the photoinitiator may be at least one selected from the group consisting of lithium phenyl-2,4,6-trimethylbenzoylphosphinate (LAP), 2,2-dimethoxy-2-phenylacetonephenone (DMPA), 2-hydroxy-2-methylpropipphenone (HOMPP), [diethyl-(4-methoxybenzoyegermyl]-(4-methoxyphenyl)methanone (Ivocerin), 1-[4-(2-hydroxyethoxy)-phenyl]-2-hydroxy-2-methyl-1-propane-1-one (IRGACURE 2959), bis-(2,4,6-trimethylbenzoyl) phenylphosphine oxide (Irgacure 819) and camphorquinone (CQ), and may preferably be LAP.

According to a preferred embodiment of the present invention, the bioprinting may be performed by at least one 3D bioprinting method selected from the group consisting of fused deposition modeling (FDM) with a light source, digital light processing (DLP), mask stereolithography (MSLA) and liquid crystal display (LCD).

The present invention may also provide a cartridge for a bioprinter including the bio-ink composition.

The present invention may also provide a method of preparing a biological structure which includes allowing a bio-ink composition prepared by the method of preparing the bio-ink composition to be irradiated with light to adjust physical properties of the bio-ink composition, or a biological structure prepared by the preparation method.

According to a preferred embodiment of the present invention, a polymer and a crosslinking agent in the composition may be photo-crosslinked.

According to a preferred embodiment of the present invention, the wavelength of the light may range from 100 to 1500 nm, preferably from 200 to 1000 nm, and more preferably from 300 to 900 nm.

According to a preferred embodiment of the present invention, the irradiation may be performed for 1 second to 60 seconds. Preferably, the irradiation may be performed for 3 seconds to 30 seconds, and more preferably, may be performed for 5 seconds to 10 seconds. When the light is irradiated for shorter than 5 seconds, the shape of the fabricated 3D scaffold may not be clearly printed, and when the light is irradiated for longer than 10 seconds, a scaffold larger than the size of the previously set 3D scaffold may be fabricated.

### Advantageous Effects

The bio-ink composition for bioprinting prepared according to the present invention can be implanted in vivo and has high biocompatibility and cell viability. Further, the bio-ink composition of the present invention can be effectively utilized for bioprinting because it is possible to fabricate a biological structure which is capable of adjusting physical properties or bioapplicable even when irradiated with light for a short period of time.

### DESCRIPTION OF DRAWINGS

FIG. 1 shows HA-MA prepared by introducing glycidyl methacrylate into hyaluronic acid (HA).

FIG. 2 shows the results of confirming HA-MA into which methacrylate was introduced by ¹H-NMR.

FIG. 3 shows glycerol trimethacrylate (GlyMA) prepared by introducing glycidyl methacrylate into glycerol.

FIG. 4 shows a scaffold printed by allowing a composition in which HA-MA bio-ink, a crosslinking agent as an ink auxiliary composition, and a photoinitiator are mixed and irradiated with ultraviolet light.

FIG. 5 shows an ink crosslinked structure of a 3D printed scaffold prepared by allowing a composition in which HA-MA bio-ink, a crosslinking agent as ink an auxiliary composition, and a photoinitiator are mixed and irradiated with ultraviolet light.

FIG. 6 shows scaffolds HM-1, HM-2, HM-3 and HM-4 prepared in the present invention.

FIG. 7 shows the swelling ratio of scaffolds HM-1, HM-2, HM-3 and HM-4 prepared in the present invention.

FIG. 8 shows the storage modulus or viscosity of scaffolds HM-1, HM-2, HM-3 and HM-4 prepared in the present invention by rheological evaluation.

FIG. 9 shows the compression stress or elastic modulus of scaffolds HM-1, HM-2, HM-3 and HM-4 prepared in the present invention.

### MODES OF THE INVENTION

### Example 1

### Preparation of HA-MA

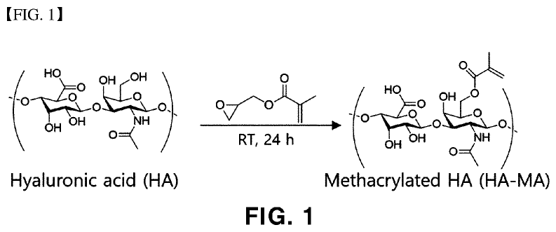

It was attempted to prepare a photo-crosslinked bio-ink (HA-MA) for bioprinting based on hyaluronic acid (HA) (FIG. 1).

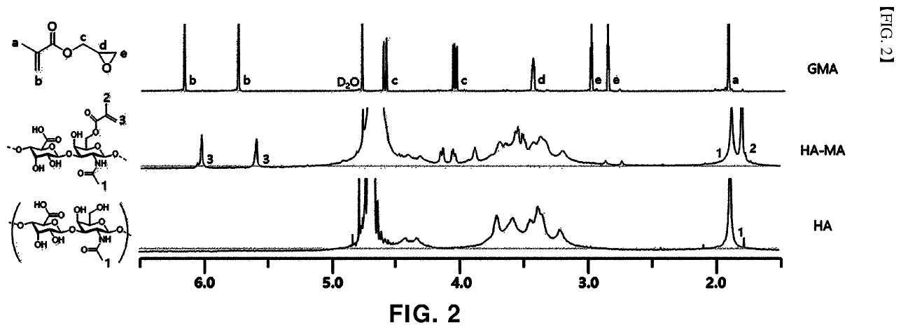

Specifically, after hyaluronic acid powder was dissolved at 1 wt % in DW, stirring was performed for about 12 hours to ensure complete dissolution. Glycidyl methacrylate (GMA) was added to the completely dissolved hyaluronic acid solution under light-blocking conditions at a constant rate at a concentration 20 times higher than that of hyaluronic acid. Thereafter, stirring was performed at room temperature for 24 hours to allow a methacrylate group to bond to the hydroxyl group of hyaluronic acid. After three days of dialysis, HA-MA powder was obtained by lyophilization at −70° C. The methacrylate introduced into the prepared HA-MA was confirmed through ¹HNMR (FIG. 2).

### Example 2

### Preparation of Ink Auxiliary Composition

Additives were added in order to reduce the printing time of the photo-crosslinked bio-ink for bioprinting and to rapidly form a structure, and additives having different numbers of (meth)acrylates were used in each single monomer. Among them, a material having three acrylates was prepared by introducing methacrylate into glycerol to increase solubility in water or PBS.

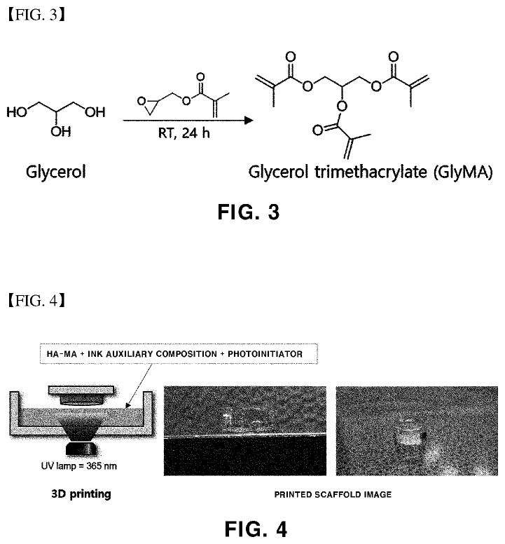

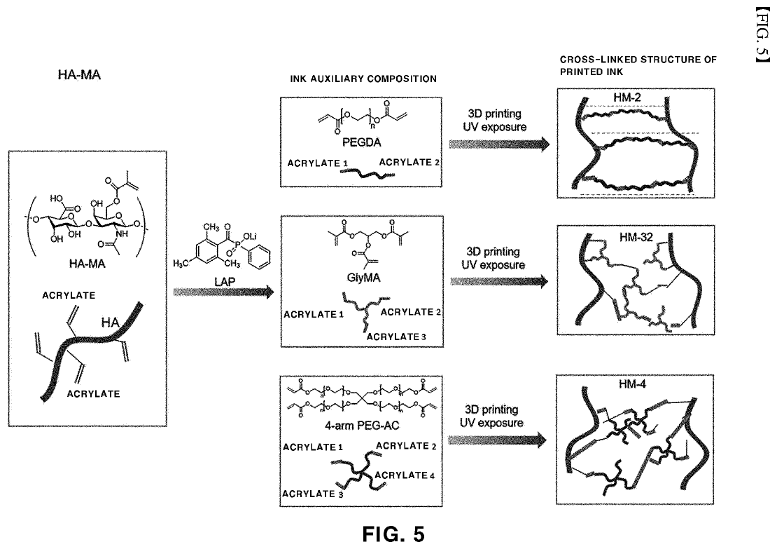

Specifically, after glycerol was dissolved at 1 wt % in DW, glycidyl methacrylate having a concentration 20 times higher than that of hyaluronic acid was added dropwise at a constant concentration, followed by stirring for 24 hours. Then, glycerol trimethacrylate was prepared through a dialysis process for three days (FIG. 3).

### Example 3

### Preparation of Photo-Crosslinked Bio-Ink for Bioprinting and Scaffold Printing

After the HA-MA powder prepared in Example 1 was dissolved at a concentration of 5 wt % n 1×PBS, 0.05 wt % of a photoinitiator (lithium phenyl-2,4,6-trimethylbenzoylphosphinate; LAP) was added thereto. In addition, PEGDA (Sigma Aldrich), GlyMA or 4-arm PEG-AC (Advanced Biochemicals) was added at a (meth)acrylate equivalent weight of 100 to 500[g/eq; molecular weight per (meth)acrylate=molecular weight of additive/number of (meth)acrylates] as a bio-ink auxiliary composition in order to impart physical property control performance of HA-MA bio-ink. The equivalent weight of PEGDA was 350 g/eq, the equivalent weight of GlyMA was 100 g/eq, and the equivalent weight of 4-arm PEG-AC was 500 g/eq.

Specifically, HA-MA only (HM-1), HA-MA+PEGDA (HM-2), HAMA+GlyMA (HM-3) and HAMA+4-arm PEG-AC (HM-4) bio-inks were completed by adding PEGDA (0.7 g, 1 mmol), GlyMA (0.2 g, 0.67 mmol) or 4-arm PEG-AC (1 g, 0.50 mmol). After each of the prepared liquid bio-inks was introduced into a build plate at the bottom of a DLP printer that prints in the form of a surface using a UV projector as a light source, printing was performed while the UV irradiation time was adjusted so that a scaffold was attached to the template. The scaffold to be printed was in the form of a cylinder with a diameter of 6 mm and a height of 1 mm, and printing conditions were 6 seconds of light irradiation time per layer based on UV=365 nm, and the height of each layer was 100 μm (FIG. 4).

### Example 4

### Identification of Swelling Ratio of Scaffold

The HM-1, HM-2, HM-3 or HM-4 scaffold prepared in Example 3 was added to a 60 mm petri dish, respectively. After 10 ml of PBS was added thereto, the PBS on the surface of the petri dish was removed using clean wipes at regular intervals at 37° C. Thereafter, the weight of the swollen scaffold was obtained by measuring the weight of the petri dish, and after lyophilization for about 7 days, the weight of the petri dish was measured to obtain the weight of the dried scaffold. The same process was repeated three times, and the swelling ratio was calculated using the following Equation.

Swelling ratio (%)=(weight of swollen scaffold−weight of dried scaffold)/weight of dried scaffold×100 [Equation]

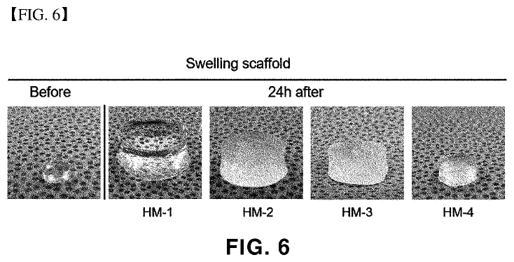

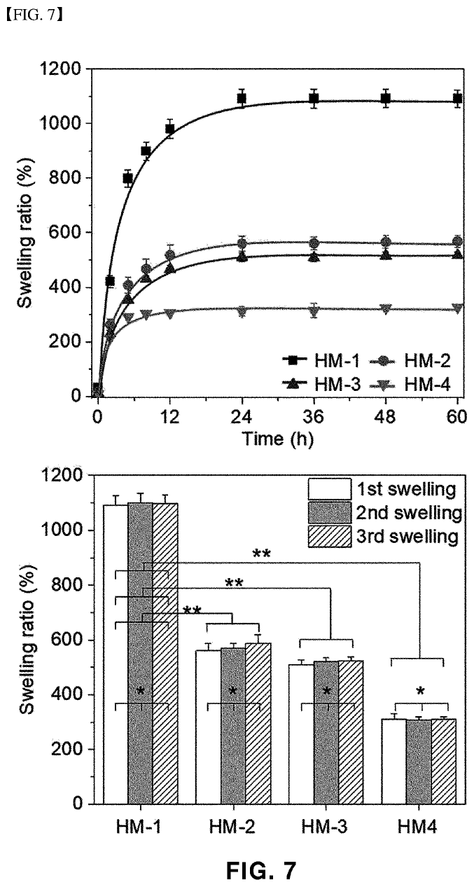

In all groups, there was no change in swelling ratio after 24 hours, and in the case of the HM-1 scaffold, the swelling ratio exceeded 1000% after 24 hours, whereas it was confirmed that, in the case of HM-2, HM-3 or HM-4, the swelling ratio increased by about 600%, 500% or 300%, respectively. The same result was confirmed when the process was repeated three times. It was confirmed that the swelling ratio decreased as the number of acrylates in the ink auxiliary composition increased (FIGS. 6 and 7).

### Example 5

### Rheological Evaluation of Scaffold

The rheological properties of the HM-1, HM-2, HM-3 or HM-4 group prepared in Example 3 were analyzed using an MCR 102 rheometer (Anton Paar GmbH, Austria). An experiment was conducted under the condition of a 0.5 mm gap at 25° C. using a 25 mm stainless steel plate. After an amplitude value was fixed to 1%, rheological properties were measured by varying the frequency from 0.1 to 100 Hz. Then, when the result value according to the amplitude change was measured, the frequency was fixed at 1 Hz, and then the measurement was performed by varying the amplitude from 0.01 to 100%.

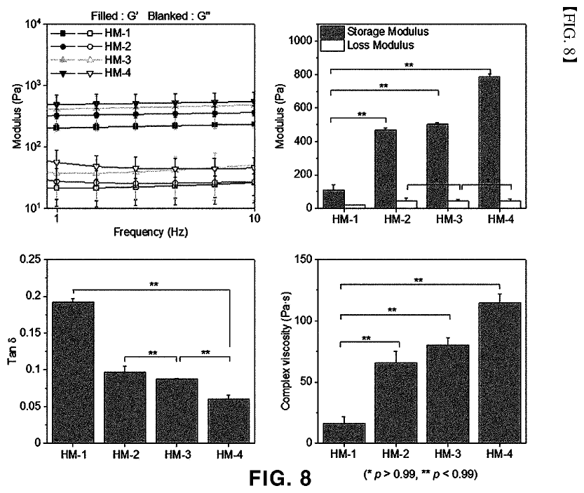

As a result, as shown in FIG. 8, it was confirmed that the group to which PEGDA, GlyMA, or 4-arm PEG-AC was added had a higher storage modulus value than that of the HM-1 only group. In addition, tan 6 values, which are loss modulus/storage modulus values, were all less than 1, from which it was confirmed that the scaffolds had the characteristics of a gel. Viscosity also increased as the number of acrylates in the ink auxiliary composition increased, and specifically, the viscosity was about 4 to 7 times higher than that of the HM-1 only group. This indicated that when the same equivalent amount of the ink auxiliary composition was added, the scaffold became more rigid as the number of acrylates increased.

### Example 6

### Evaluation of Compressive Strength of Scaffold

The compressive modulus of HM-1, HM-2, HM-3 or HM-4 group prepared in Example 3 was measured using an H5KT universal testing machine (Tinius-Olsen, Horsham, PA, USA). The compressive modulus was measured at 1 mm/min using a 5N load cell until the scaffold was broken, and then was calculated at 20% strain in the initial linear region.

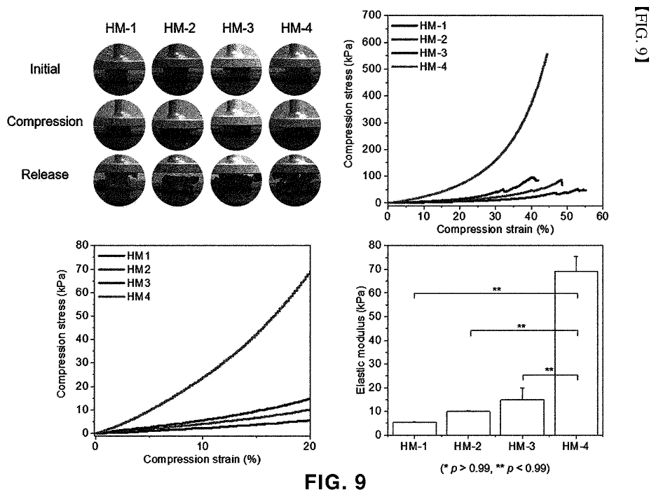

As a result, as shown in FIG. 9, in the case of the HM-1 and HM-2 groups, when the released scaffolds were compared after the scaffolds were broken, the scaffolds were not completely broken and maintained their original shape, but in the case of the HM3 and HM4 group, it was confirmed that the scaffolds were completely broken. Further, when the HM1, HM2, HM3 and HM4 groups were compared at 20% strain in the initial linear region, the groups to which PEGDA, GlyMA or 4-arm PEG-AC were added had higher stress and compressive modulus.

This indicated that, according to the degree of crosslinking inside the scaffold depending on the additive, the more the number of acrylate branches in the additive, the higher the degree of crosslinking, and thus the original shapes of the scaffolds were completely lost when the scaffolds were broken and then released.

### INDUSTRIAL APPLICABILITY

The bio-ink composition for bioprinting prepared according to the present invention can be implanted in vivo and has high biocompatibility and cell viability. In addition, the bio-ink composition of the present invention can fabricate a biological structure that can adjust physical properties or is bioapplicable even when irradiated with light for a short period of time, and thus can be effectively utilized for bioprinting and has high industrial applicability.

1. A method of preparing a bio-ink composition for bioprinting, comprising mixing a polymer into which methacrylate is introduced, a crosslinking agent having 1 to 10 acrylate functional groups, and a photoinitiator.

2. The method according to claim 1, wherein the polymer is one or more selected from the group consisting of hyaluronic acid, chitosan, collagen, alginate, gelatin, albumin, carrageenan, Matrigel, hemoglobin, heparin, fibrin-gel and agarose.

3. The method according to claim 1, wherein the crosslinking agent is one or more selected from the group consisting of polyethylene glycol diacrylate (PEGDA), glycerol trimethacrylate (GlyMA) and multi-arm polyethylene glycol (PEG).

4. The method according to claim 1, wherein an equivalent weight of the crosslinking agent is in a range of 10 to 1000.

5. The method according to claim 1, wherein the photoinitiator is one or more selected from the group consisting of lithium phenyl-2,4,6-trimethylbenzoylphosphinate (LAP), 2,2-dimethoxy-2-phenylacetonephenone (DMPA), 2-hydroxy-2-methylpropipphenone (HOMPP), [diethyl-(4-methoxybenzoyl)germyl]-(4-methoxyphenyl)methanone (Ivocerin), 1-[4-(2-hydroxyethoxy)-phenyl]-2-hydroxy-2-methyl-1-propane-1-one (IRGACURE 2959), bis-(2,4,6-trimethylbenzoyl) phenylphosphine oxide (Irgacure 819) and camphorquinone (CQ).

6. The method according to claim 1, wherein the bioprinting is performed by one or more 3D bioprinting methods selected from the group consisting of fused deposition modeling (FDM) with a light source, digital light processing (DLP), mask stereolithography (MSLA) and liquid crystal display (LCD).

7. A method of preparing a biological structure, comprising allowing a bio-ink composition prepared by the method according to claim 1 to be irradiated with light to adjust physical properties of the bio-ink composition.

8. The method according to claim 7, wherein a polymer and a crosslinking agent in the composition are photo-crosslinked.

9. The method according to claim 7, wherein a wavelength of the light ranges from 100 nm to 1500 nm.

10. The method according to claim 7, wherein the irradiation is performed for 1 second to 60 seconds.

11. A bio-ink composition for bioprinting prepared by the method according to claim 1.

12. (canceled)

13. (canceled)
